(19) United States
(12) Patent Application Publication
(10) Pub. No.: US 2012/0187184 A1
(43) Pub. Date: Jul. 26, 2012

(54) Method and Apparatus for Communicating Information with a Personal Electronic Device via NFC and Light-Simulated Bar Codes

(75) Inventors: Nagesh Challa, Saratoga, CA (US); Venkata T. Gobburu, San Jose, CA (US); Michel E. Gannage, Los Altos Hills, CA (US)

(73) Assignee: MOBEAM INC., Cupertino, CA (US)

(21) Appl. No.: 13/186,257

(22) Filed: Jul. 19, 2011

Related U.S. Application Data
(60) Provisional application No. 61/365,772, filed on Jul. 19, 2010.

(51) Int. Cl. G06F 17/00

(52) U.S. Cl. 235/375

(57) ABSTRACT

The techniques described herein facilitate the reliable and widespread communication of information in support of various types of transactions at various types of facilities using personal electronic devices, which are electronic devices that can be easily carried on the person. Personal electronic devices may be enabled to access and communicate information using Near Field Communications (“NFC”), as well as to communicate information to bar code scanners by emitting light that simulates a reflection of a scanning beam being moved across a static visual image of a bar code. Such a personal electronic device may be used for transactions both at the relatively uncommon facilities which have the newer NFC systems as well as the many facilities which have the older bar code scanners, thereby enhancing its value to its user. Moreover, NFC and light-simulated bar codes may be used cooperatively on a personal electronic device to enable a variety of novel and useful methods of communicating information.

### CROSS-REFERENCE TO RELATED APPLICATIONS

This application claims the benefit of U.S. Provisional Patent Application Ser. No. 61/365,772 filed Jul. 19, 2010, which hereby is incorporated herein in its entirety by reference thereto.

### BACKGROUND OF THE INVENTION

1. Field of the Invention

This invention relates generally to communicating information with a personal electronic device, and more particularly to methods and apparatus for communicating information using a personal electronic device in support of a transaction via Near Field Communication and light-simulated bar codes.

2. Description of the Related Art

The use of bar code scanners in a great many aspects of everyday life is commonplace. Bar code scanners are found in many different types of facilities, including supermarkets, airport security, check-in and boarding areas, stadiums, libraries, test centers, conference centers, and many other places. The use of bar code scanners has dramatically increased the speed at which many commonplace transactions can be completed.

While typically printed on paper labels and stubs, bar codes have also been presented on the electronic displays of mobile communications devices; see, for example, International Publication No. WO 00/03328 Published Jan. 20, 2000 in the name of applicant Motorola Inc. However, reading bar codes from displays has been problematical. A technology that simulates a bar code using active light and thereby overcomes various limitations of screen-displayed bar codes is disclosed in U.S. Pat. No. 6,685,093 issued Feb. 3, 2004 to Challa et al.

As prevalent as bar code scanners are, some facilities have moved on to a new technology known as Near Field Communications (“NFC”). NFC facilitates secure, short-range communication between electronic devices, such as mobile phones, PDAs, computers and payments terminals via a fast and easy wireless connection. Combined with contactless payment technology, NFC can enable secure and convenient purchases with a mobile device. Suitable types of transactions include making a purchase at a coffee shop, downloading a movie trailer in a DVD store, shopping from a TV at home, and buying concert tickets from a smart poster. An example of a NFC-enabled smartphone is the Google Nexus S smartphone available from Samsung Electronics America Inc. of Ridgefield Park, N.J., USA.

Despite the availability of some NFC-enabled smartphones and of NFC terminals as some points of sale and points of service, incorporation of NFC at points of sale and at points of service and into cellular phones has not been widespread. Persons wishing to use their NFC-enabled personal electronic devices in support of transactions at points of sale and service encounter great variation in the types of installed systems, such that their personal electronic devices may not be entirely suitable for use at some of the points of sale and service.

### BRIEF SUMMARY OF THE INVENTION

One embodiment of the present invention is an apparatus for communicating information with a personal electronic device comprising a Near Field Communications (“NFC”) transceiver; a light source; a memory; and a processor coupled to the NFC transceiver, the light source, and the memory for executing program components stored in the memory. The memory comprises a stored program component for encoding stored transmission information data from the memory into a bar code format; a stored program component for generating a signal from the from the bar code format to simulate a reflection of a scanning beam being moved across a static visual image of the bar code format; a stored program component for transmitting the signal as light pulses from the light source; a stored program component for generating a first NFC protocol signal from transmission information data stored in the memory; a stored program component for transmitting the first NFC protocol signal as an radio frequency signal from the NFC transceiver; a stored program component for detecting a radio frequency signal received at the NFC transceiver and containing a second NFC protocol signal; and a stored program component for generating and storing in the memory transmission information data from the second NFC protocol signal.

Another embodiment of the present invention is an apparatus for communicating information with a personal electronic device comprising a Near Field Communications (“NFC”) transceiver; a light source; a memory; a processor coupled to the NFC transceiver, the light source, and the memory; means for encoding stored transmission information data from the memory into a bar code format; means for generating a signal from the from the bar code format to simulate a reflection of a scanning beam being moved across a static visual image of the bar code format; means for transmitting the signal as light pulses from the light source; means for generating a first NFC protocol signal from transmission information data stored in the memory; means for transmitting the first NFC protocol signal as an radio frequency signal from the NFC transceiver; means for detecting a radio frequency signal received at the NFC transceiver and containing a second NFC protocol signal; and means for generating and storing in the memory transmission information data from the second NFC protocol signal.

Another embodiment of the present invention is a method for communicating information with a personal electronic device having a memory, a light source and a Near Field Communications (“NFC”) transceiver, comprising detecting a radio frequency signal received at the NFC transceiver and containing a NFC protocol signal; generating and storing in the memory transmission information data from the NFC protocol signal; encoding the transmission information data from the memory into a bar code format; generating a signal from the from the bar code format to simulate a reflection of a scanning beam being moved across a static visual image of the bar code format; and transmitting the signal as light pulses from the light source.

### BRIEF DESCRIPTION OF THE SEVERAL VIEWS OF THE DRAWINGS

FIG. 1 is a schematic block diagram of a control circuit.

FIG. 2 is a plan view of a fob for which the control circuit of FIG. 1 is suitable.

FIG. 3 through FIG. 8 are flowcharts of various methods which use NFC for certain purposes in conjunction with active light for providing transmission information data to a bar code scanner.

FIG. 9 is a plan view of an illustrative one-dimensional bar code;

FIG. 10 is a flow chart of a method of actively providing transmission information data to a bar code scanner;

FIG. 11 is a graph of a characteristic of a signal representing the bar code of FIG. 9 against time.

### DETAILED DESCRIPTION OF THE INVENTION, INCLUDING THE BEST MODE

The techniques described herein facilitate the reliable and widespread communication of information in support of various types of transactions at various types of facilities using personal electronic devices. Personal electronic devices are electronic devices that can be easily carried on the person, and include such as mobile phones, personal digital assistants (“PDA”), gaming devices, audio and video players, fobs, and USB Flash drives. Personal electronic devices are suitable for many uses, including communications, entertainment, security, commerce, guidance, data storage and transfer, and so forth, and may be dedicated to a particular use or may be suitable for many different uses. These techniques described herein enable the large and growing population of personal electronic devices to effectively use various communications protocols to interact with both new and old commercial infrastructure, including infrastructure which is dependent on bar code scanners as well as infrastructure using NFC.

Personal electronic devices may be enabled to communicate information to a bar code scanner by using built-in light sources. These devices have light sources such as the device screen, infrared ports, and LEDs that may be driven by a simulated signal so that light from the light source simulates a reflection of a scanning beam being moved across a static visual image of the bar code. The technique for communicating information to a bar code scanner with light that simulates a reflection of a scanning beam being moved across a static visual image of the bar code may be referred to as “light-simulated bar code” and is described in, for example, U.S. Pat. No. 6,877,665 issued Apr. 12, 2005 to Challa et al., U.S. Pat. No. 6,685,093 issued Feb. 3, 2004 to Challa et al., U.S. Pat. No. 7,028,906 issued Apr. 18, 2006 to Challa et al., U.S. Pat. No. 7,395,961 issued Jul. 8, 2008 to Challa et al., and U.S. Pat. No. 7,967,211 issued Jun. 28, 2011 to Challa et al., all of which hereby are incorporated herein in their entirety by reference thereto. The term “light” is a broad term which includes infrared light as well as visible light.

Personal electronic devices may also be enabled to access and communicate information using built-in Near Field Communications (“NFC”). NFC wirelessly operates over a short range, typically under about 4 cm, and typically at a frequency of 13.56 MHZ. NFC may operate in various modes such as, for example, Card Emulation Mode, Peer-to-Peer Mode, and Reader-Writer Mode. Card Emulation Mode permits the personal electronic device to be used to perform secure transactions such as mobile payments, including smart card like transactions. Peer-to-Peer Mode permits data transfer between two NFC devices in proximity to one another for services as diverse as mobile ticketing transactions and exchange of business cards. Reader-Writer Mode permits a one-way data acquisition of information. The personal electronic device may, for example, read a NFC tag or Radio Frequency Identification (“RFID”) tag to acquire information such as, for example, text, URL's and contact information. In other applications, the personal electronic device may, for example, emulate a NFC or RFID tag so as to provide text, URL's and contact information to a tag reader. For RFID tag reading and emulation, a circuit within the personal electronic device may be configured to operating at a suitable radio frequency such as, for example, 0.125-0.1342, 0.140-0.1485, 13.56, or 840-960 MHz; and includes an antenna suitable for inductively coupling at one or more of these RF frequencies with an RFID reader. The term “NFC” as used herein is a broad term which is inclusive of “RFID” but is not essentially defined by RFID. In this sense, a RFID tag may be considered a type of NFC tag, but a NFC tag does not require the particular attributes of a RFID tag. Similarly, a RFID reader may be considered to be a type of NFC reader, but a NFC reader does not require the ability to read RFID tags.

Personal electronic devices having no inherent ability to communicate information to a bar code scanner with light-simulated bar codes, or to communicate or access information using NFC, may be enabled to do so by the use of an accessory. The accessory may be a separate device that is used with a personal electronic device either as an attachment or add-on to the personal electronic device, or as a stand-alone device. Alternatively, the accessory may be built into a removable component of the device, such as a battery cover or removable face plate. Such accessories and other suitable apparatus and methods are described in U.S. Pat. No. 7,857,225 issued Dec. 28, 2010 to Challa et al., which hereby is incorporated herein in its entirety by reference thereto.

When enabled both for NFC and light-simulated bar codes, a personal electronic device may be used for transactions both at the relatively uncommon facilities which have the newer NFC systems as well as the many facilities which have the older bar code scanners, thereby enhancing its value to its user. Moreover, NFC and light-simulated bar codes may be used cooperatively on a personal electronic device to enable a variety of novel and useful methods of communicating information.

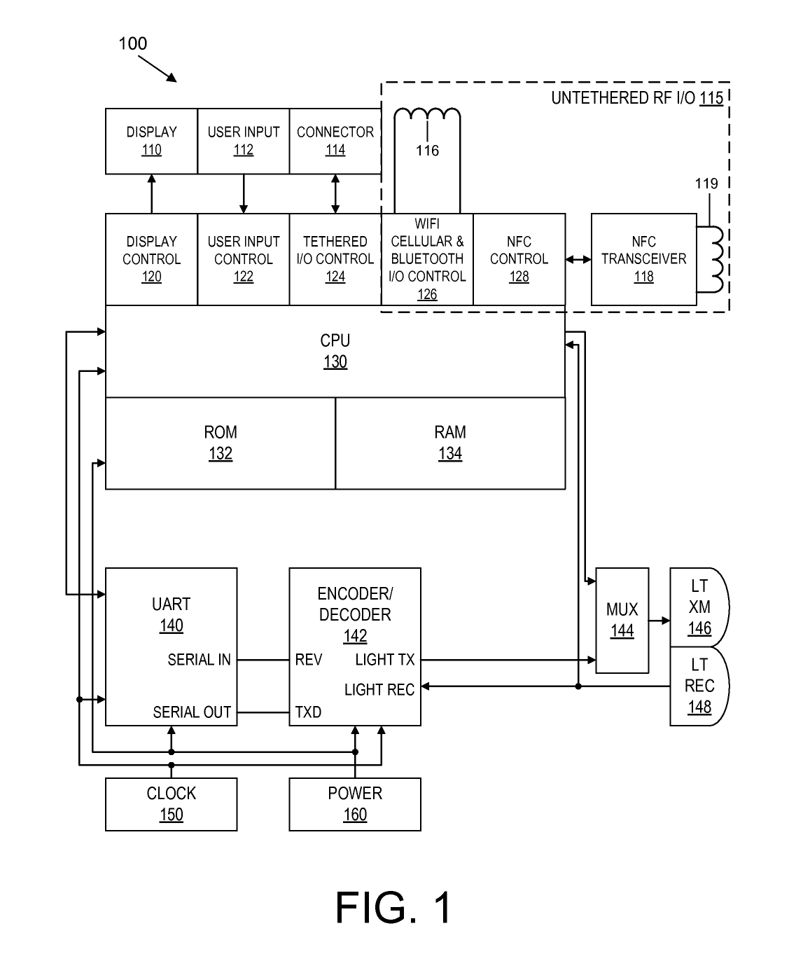

An example of a control circuit 100 for a fob-type device which includes a display and is enabled for communication via both light-simulated bar codes and NFC is shown in FIG. 1. The circuit 100 includes a tethered input/output control 124 (e.g., a USB port, an RS232 serial port, a parallel port, a multipurpose connector such as the proprietary interface connector used in the iPhone, iPad and iPod devices available from Apple Computer Inc. of Cupertino, Calif., USA, and so forth) and associated connector 114, an untethered RF I/O 115, a light transmitter 146 and a light receiver 148 collectively forming a light transceiver 149, a CPU 130, a read-only memory (“ROM”) 132, a random access memory (“RAM”) 134, a clock 150, and a power supply 160. The circuit 100 may include preprogrammed transmission information data stored in ROM 132 or other nonvolatile memory such as an EEPROM, and may further receive transmission information data from an external source via the tethered capability (connector 114 and tethered I/O control 124), the untethered RF I/O 115, the light receiver 148, or any other information transmission path provided. Secure information including applications may be stored in a Universal Integrated Circuit Card (“UICC” also known as a SIM card) (not shown). User or device identification codes, for example, may be preprogrammed into the ROM 132 to identify the device and/or user, and/or to provide security. The CPU 130 receives incoming information from the tethered capability, the untethered RF I/O 115, the light receiver 148, or any other information transmission path provided, and stores it in the RAM 134 for possible encoding and retransmission to, for example, a bar code scanner or a NFC receiver, or for configuring a NFC tag or a RFID tag. The CPU 130 operates under the control of one or more programs, the components of which are stored in either the ROM 132 or the RAM 134 or distributed across both the ROM 132 and the RAM 134.

The circuit 100 also includes a Universal Asynchronous Receiver/Transmitter circuit (“UART”) 140, an encoder/decoder 142, a multiplexer 144, a light transmitter 146, and a light receiver 148. In this embodiment, data may be received via the light receiver component 148 of the transceiver 149 in any suitable light format, including IrDA format. The data is decoded by the encoder/decoder 142 and stripped of start and stop bit information by the UART 140. The data is then provided to the CPU 130 for processing or for storage in the RAM 134. Data may also be received via the tethered capability (connector 114 and tethered I/O control 124) and the untethered RF I/O 115, and then provided to the CPU 130 for processing or for storage in the RAM 134.

The untethered RF I/O 115 may include various wireless communications capabilities, including but not limited to such well known communications capabilities as Wi-Fi, cellular and Bluetooth™ capabilities, which may be implemented using suitable Wi-Fi, cellular and Bluetooth I/O controllers (collectively shown as controller 126) and suitable antenna (collectively shown as antenna 116). In addition, the untethered RF I/O 115 may include an NFC controller 128, an NFC transceiver 118, and a suitable antenna 119. In cooperation with the CPU 130, these components may implement various modes such as, for example, Card Emulation Mode, Peer-to-Peer Mode, and Reader-Writer Mode, in accordance with established protocols. In addition, these components may establish a NFC tag or mimic a RFID tag so that desired information may be provided to NFC and RFID readers.

The circuit 100 may also include the capability of communicating information with active light. For applications in which communication with a bar code scanner is desired, the CPU 130 retrieves stored transmission information data from the ROM 132 and/or the RAM 134, encodes it into a bar code format, and generates a signal simulating the reflection of a scanning beam being moved across a visual image of a bar code corresponding to the transmission information data. The signal is provided to the light transmitter 146 through the multiplexer 144 for transmitting light pulses from the light transmitter 146 to a bar code scanner. For applications in which one may wish to transmit data in light-related communication protocol such as an IrDA communication protocol, the data may be retrieved from the ROM 132 and/or the RAM 134, transferred to the UART 140 for the addition of stop and start bit information, and then transferred to the encoder/decoder 142 for encoding into the proper light format for transmission by the light transmitter 146 via the multiplexer 144.

If desired, the CPU 130 may also respond to the light receiver 148 to provide for detection of a scanning beam from a bar code scanner. Various scan parameters including the scan rate of the bar code scanner over one or more scan cycles, may be determined from the detected scanning beam by the CPU 130, and used to optimize the simulated signal, as described in U.S. Pat. No. 6,877,665 issued Apr. 12, 2005 to Challa et al., which hereby is incorporated herein in its entirety by reference thereto. The detection of a scanning beam may also be used to select active light communications using light that simulates a reflection of a scanning beam being moved across a static visual image of the bar code.

The display control 120 and user input control 112 (illustratively a virtual or actual key pad, for example) elements of the control circuit 100 may be operated to cause display of representative information for each of the stored transmission information data codes, to scroll through each of the codes, and to select a particular code for transmission to a bar code scanner. The display 110 may also be used as the output port for transmission of transmission information data to a bar code scanner. In this implementation, the display 110 may be alternated between on and off, or between relatively bright and relatively dark settings, or between different colors such as red and blue, to simulate the reflection of a scanning beam moving across a conventional bar code. Any aspect of the display that may be changed and recognized by a bar code scanner receiver may be utilized. If a bar code imager is in use, a static bar code may be shown on the display 110.

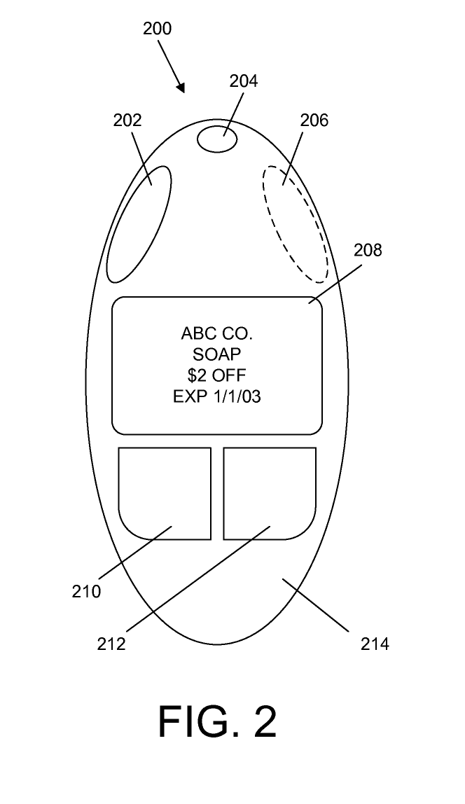

The control circuit shown in FIG. 1 illustratively is suitable for a fob device, an example being fob 200 shown in FIG. 2. The fob 200 not only provides for transmission of data to a bar code scanner through the light transmitter 204, but also provides for reception of data through a light port 202 and embedded RF antennas 206. The ports 202, 204 and 206 are merely illustrative and may be designed to be any fob-compatible size or shape for most effectively performing their function. The fob 200 includes a small display screen 208 and a small key pad having one or more keys such as keys 210 and 212. The display screen 208 may be used to display representative information and to identify particular transmission information data to a user. One of the keys of the key pad may be used to scroll through lists to find the particular transmission information data that the user wishes to transmit to a particular bar code scanner, NFC device, or RFID reader. Thus, the fob device 200 may store multiple different pieces of information, such as coupons, admission tickets, credit card information, and so forth, which may be selected and transmitted to bar code scanners, NFC devices, and RFID readers at times and places as desired by the user. The display screen 208 may also, or alternatively, be used to display static visual image of a bar code or other representative image. The display screen 208 may be used to display a short bar code for communicating conventionally with a bar code scanner. Further, a moderate to high resolution display, for example, may be used to display a moderate or high density representative image, such as, but not limited to a two-dimensional bar code. Such an image may be read by an imaging reader, such as a charge coupled device (CCD) reader. One of the keys of the key pad may also be used to select particular modes of operation. One such mode may be, for example, an RFID reader mode so that the fob 200 may be used to acquire information from an RFID tag. The fob housing 214 has a small form factor with rounded edges for user convenience.

At points-of-sale and points-of-service, the fob device 200 under control of the control circuit 100 may communicate the selected information using available techniques all or a subset of the most commonly used of the available techniques suitable for point-of-sale and point-of-service transactions, including, for example, light that simulates a reflection of a scanning beam being moved across a static visual image of the bar code, a static barcode image, representative information, NFC and RFID. While less popular at points-of-sale and points-of-service, the fob device 200 also supports other protocols such as the Wi-Fi, Bluetooth™, and cellular protocols via the I/O control 126, and various encoded light protocols such as the Infrared Data Association (“IrDA”) and the Infrared Financial Messaging (“IrFM”) protocols via the light transmitter 146 and light receiver 148. The fob 200 may transmit transmission information data in the various formats or protocols sequentially and/or contemporaneously. Advantageously, the user need not be at all concerned with the type of equipment at the facility, but need only present the fob 200 in a natural and intuitive matter to the sensing portion of the equipment. Alternatively, the fob 200 may monitor or query the environment to detect the type of equipment at the facility, and automatically select one or more of the techniques based on the results. If an NFC signal is detected, NFC may be used. If a scanning beam is detected, light that simulates a reflection of a scanning beam being moved across a static visual image of the bar code may be used. If no signal is detected, representative information and the bar code may be displayed on the screen. Alternatively, the user may select a specific technology by means of a menu, dedicated buttons, text entry, or any other suitable manner. In any case, the availability of numerous communications technologies in one personal electronic device or in the combination of a personal electronic device with an accessory therefore provides an agreeable and seamless or nearly seamless experience to the user for a wide variety of transactions at a variety of facilities, including mobile payment transactions as well as ticket and coupon redemption.

Fob devices have certain advantages over other types of personal electronic devices. Advantageously, fob devices may be manufactured at lower cost than cellular phones or many other types of personal electronic devices, and therefore are useful not only during the time needed for manufactures to widely implement NFC technology in personal electronic devices, but also as lower-cost alternatives to upgrading to a new personal electronic device, or as a backup or alternative to other types of personal electronic devices.

While fob devices have certain advantages, other types of personal electronic devices may have their own particular advantages when combined with NFC, RFID and active light communications technology. The control circuit shown in FIG. 1 may be modified and adapted through hardware, firmware or software changes for use in any type of personal electronic device. Some types of personal electronic devices need not incorporate all of the capabilities shown in FIG. 1, while other types of personal electronic devices may include all of the capabilities as well as additional components and capabilities such as a ground positioning system (“GPS”) receiver, a laser scanner for acquisition of bar coded information, and so forth. An example of a very simple but nonetheless useful type of personal electronic device is a fob having NFC and active light communications with a minimal user interface, illustratively only an activation switch and no display screen. An example of a very powerful personal electronic device is a smartphone having NFC and active light communications along with the many capabilities provided by smartphones such as the Android Smartphones which are available from various manufacturers including Samsung Electronics America Inc. of Ridgefield Park, N.J., USA, and the iPhone™ mobile digital device which is available from Apple Computer Inc. of Cupertino, Calif., USA. The housing of such smartphones have a variety of different form factors and dimensions. Another example of a very powerful personal electronic device is a tablet having NFC and active light communications along with the many capabilities provided by various tablets such as the iPad tablet available from Apple Computer Inc. of Cupertino, Calif., USA; and the Kindle wireless reading device available from Amazon.com Inc. of Seattle, Wash., USA. The housing of such tablets have a variety of different form factors and dimensions.

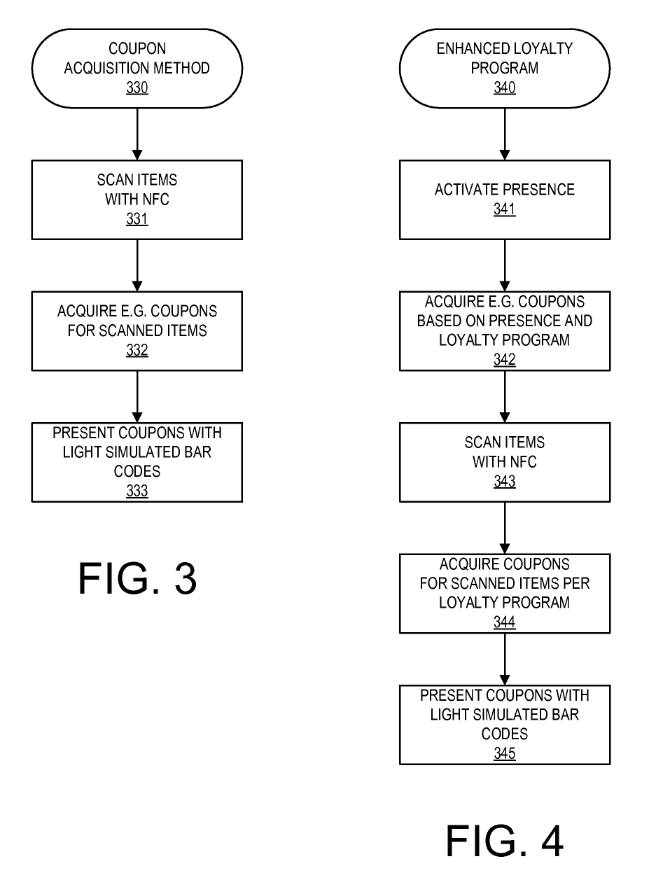

Increasingly, points of sale and points of service are being provided with NFC terminals. Moreover, many items are provided with embedded NFC or RFID tags, including items on public display as well as available from a facility, even facilities such as retail establishments that are not equipped with RFID readers or NFC terminals at the checkout counter. NFC and RFID tags are also used in connection with facilities and publicly viewable displays such as posters, transit routes and timetables, and so forth. Personal electronic devices having NFC and light-simulated bar code capabilities may be used to take advantage of NFC terminals and embedded NFC and RFID tags in order to provide benefits to consumers and operators of facilities which may have only bar code scanners. A number of illustrative methods are shown in FIG. 3 through FIG. 8.

A personal electronic device having both NFC and light-simulated bar code capabilities may be used to acquire transmission information data, such as, for example, a coupon from an NFC terminal or from a product promotion tag in a store, and then redeem the coupon immediately or at the consumer's convenience using either NFC or light-simulated bar codes at a point of sale or point of service. FIG. 3 is a flowchart 330 showing an example of a coupon acquisition method where NFC is used in reader-writer mode in conjunction with a transaction at a facility equipped with bar code scanners. Illustratively, the customer may scan items of interest using NFC Reader-Writer Mode (block 331). Coupons may be acquired (block 332) directly by receiving the bar code as text, or may be acquired online using text and URL information acquired from the NFC tag or RFID tag. In the later case, the personal electronic device performs an online search for applicable incentive and promotional information, including coupons, using the fastest available wireless connection, typically either a Wi-Fi network or cellular data network, and acquires all applicable coupons. The coupons and other appropriate incentive and promotional material is presented to a bar code scanner at checkout using light-simulated bar codes (block 333).

FIG. 4 is a flowchart 340 showing an example of an enhanced customer loyalty program where NFC is used in Reader-Writer Mode in conjunction with a transaction at a facility equipped with bar code scanners. The customer activates her presence in the facility in any available manner, illustratively by activating a loyalty program application on the personal electronic device, or by scanning a NFC tag or RFID tag embedded in a notification placard or display provided by the facility for this purpose (block 341). Using the text and URL information acquired from the NFC tag or RFID tag or under control of the loyalty program application, the personal electronic device interacts with one or more servers affiliated with the loyalty program to acquire and inform the customer of incentive and promotional information, including coupons, using the fastest available wireless connection, typically either a Wi-Fi network or cellular data network, and acquires all applicable coupons (block 342). If desired, the customer may scan items of interest in the facility using NFC in Reader-Writer Mode (block 343). Using text and URL information acquired in this manner, the personal electronic device again interacts with one or more servers affiliated with the loyalty program and performs an online search for incentive and promotional information available to loyalty program customers for these specific goods, including coupons, using the fastest available wireless connection, typically either a Wi-Fi network or cellular data network, and acquires all desired coupons (block 344). The coupons and other appropriate incentive and promotional material is presented to a bar code scanner at checkout using light-simulated bar codes (block 345).

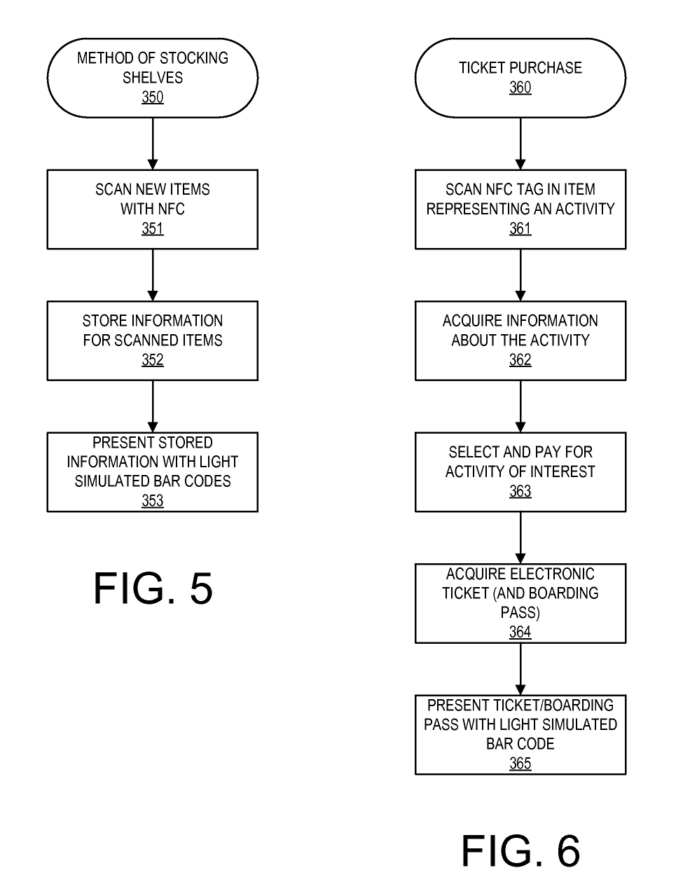

FIG. 5 is a flowchart 350 showing an example of a method of stocking shelves and taking inventory where NFC is used in Reader-Writer Mode at a facility equipped with bar code scanners. The employee may scan the new items using NFC in Reader-Writer Mode (block 351). Either a general purpose or specialized personal electronic device may be used. The relevant text and URL information acquired from the NFC scan is stored in a new inventory data base on the personal electronic device (block 352). When stocking is complete or at various times during the stocking process, the new inventory data base is presented to a bar code scanner used for inventory control using light-simulated bar codes. (block 353).

FIG. 6 is a flowchart 360 showing an example of a ticket purchase where NFC may be used in Reader-Writer Mode and Card Emulation Mode, and in conjunction with a transaction at a facility equipped with bar code scanners. The customer may scan a NFC tag or RFID tag embedded in an item representing the activity for which the ticket is desired, such as, for example, a transit timetable display board, an event poster, and so forth (block 361). Using the text and URL information acquired in this manner, the personal electronic device interacts with one or more servers and acquires whatever information is desired or available about the activity, such as an interactive version of the transit timetable or information about date, venue and cost options for events such as sports, theaters and movies (block 362). The customer may then select the activity of interest and pay for it (block 363). Various electronic payment options may be available, including a conventional online transaction if the personal electronic device is so equipped, payment at an NFC-equipped kiosk or ticket office using the Card Emulation Mode of the personal electronic device, or payment at a bar code scanner-equipped kiosk or ticket office or any payment center using a light-simulated bar code. The ticket information is then acquired by the personal electronic device in any suitable manner (block 364), including an online download of the ticket, or electronic receipt of the ticket from an NFC terminal using NFC Peer-to-Peer mode, including at the event itself from a NFC terminal at the “will call” window or a kiosk. In the case of air travel, the ticket may be used to check in online, or at a NFC terminal at an airport kiosk using NFC Peer-to-Peer Mode, for example, to obtain a boarding pass. The ticket or boarding pass may be presented to a bar code scanner using a light-simulated bar code when entering into a facility in which the activity is to occur (block 365).

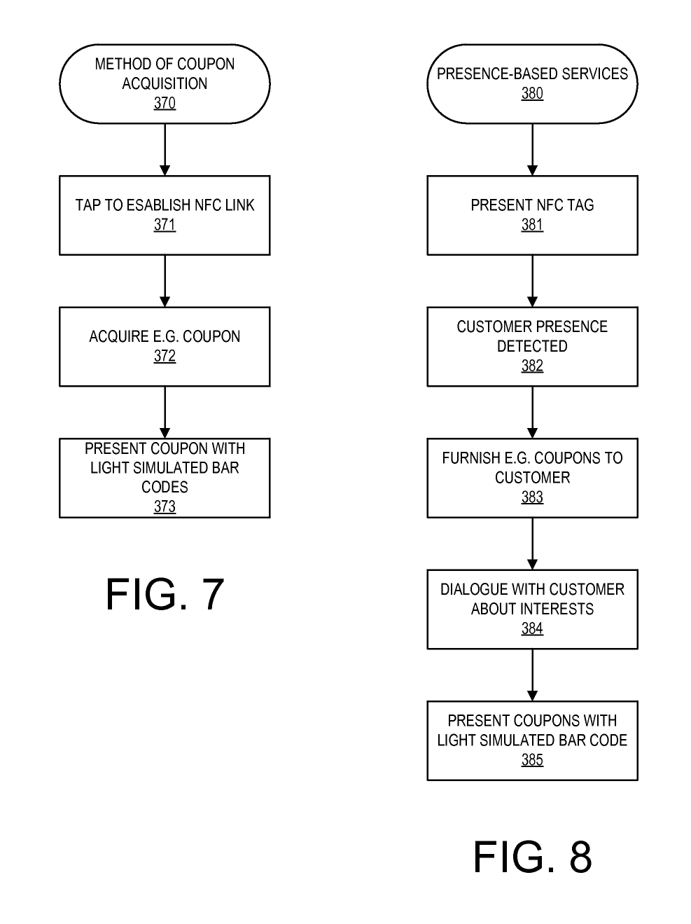

FIG. 7 is a flowchart 370 showing an example of a coupon or item information acquisition method where NFC is used in peer-to-peer mode, as between two persons or in conjunction with a transaction at a facility equipped with bar code scanners. At a retail facility, for example, the retail facility may acquire information about the customer for its advertising purposes, while the customer may acquire promotional or incentive information such as a coupon or information about an item of interest. As between two friends, they may share coupon, calendar, and other information of interest. To establish the link for the exchange of information, two NFC-enabled personal electronic devices or a NFC-enabled personal electronic device and a NFC terminal need only be brought into close proximity by, for example, tapping their NFC Target Marks (block 371). The information exchanged may be text, contact information or URL's. The coupon or other incentive or promotional information including bar code may be acquired (block 372) in text form or as a URL. If received as a URL, the personal electronic device may perform an online search either for a specific coupon or for applicable incentive and promotional information, including coupons, for the particular item of interest using the fastest available wireless connection, typically either a Wi-Fi network or cellular data network. The coupon or other appropriate incentive and promotional material may be presented to a bar code scanner at checkout using a light-simulated bar code (block 373).

FIG. 8 is a flowchart 380 showing an example of presence-based services using NFC in conjunction with a transaction at a facility equipped with bar code scanners. The customer's personal electronic device is configured to present a NFC tag identifying the customer as a member of the loyalty program associated with the facility (block 381). This configuration may be done by the customer by activating an application, or may be automatically performed by a geo-location application as the customer moves into proximity with the facility. When the customer enters into the facility, the security gates or other NFC tag reader senses the presence of the customer and reports the customer's presence to participating servers (block 382). Where the facility is a retail establishment, such servers may include the server handling the establishment's loyalty program as well as servers of various manufacturers whose products are handled by the retail establishment. These servers may then provide various incentives and promotional material to the customer's personal electronic device (block 383). Optionally the servers may engage in a dialogue with the customer via the customer's personal electronic device to ascertain the customer's immediate interests (block 384), which may be taken into account in determining which incentives and promotional material to provide. The customer may review the incentive and promotional information, make her selections, and present the appropriate coupons at checkout using light-simulated bar codes (block 385).

The technique of activating presence described in connection with FIG. 8 is interchangeable with other techniques of activating presence, such as by activating the loyalty program application on the personal electronic device or, using NFC in Reader-Writer Mode, by scanning a NFC tag embedded in a notification placard or display provided by the facility for this purpose, as described in connection with FIG. 4.

There are a great many different types of personal electronic devices, both which are well known and commercially available today, as well as a myriad of new devices that are likely to be introduced. These devices exhibit great variety in their user input capabilities and display capabilities. Examples of one type of personal electronic device, the mobile communications device, includes personal data assistants (“PDAs”) operating under such operating systems as the Palm™ operating system and the Windows™ CE and Windows Mobile® operating systems, a SmartPad notepad such as is available from Seiko Instruments of Torrance, Calif., and equipped with a wireless PDA device, two-way pagers, some types of consumer wireless Internet access devices (“CADs”) and Internet appliances, GSM phones, WAP-enabled phones, as well as Java™-enabled and BREW®-enabled phones available from various manufacturers such as Nokia of Helsinki, Finland, and Sony-Ericsson Mobile Communications, Inc. of Research Triangle Park, N.C., personal communication system (“PCS”) phones, multi-function wireless FOMA phones with the iMODE browser available from NTT Docomo of Tokyo, Japan. Further examples of electronic devices that may be used within the scope of the present invention include a communications-enabled personal data assistant. Many different kinds of communications-enabled PDAs are available. Examples include the various handhelds, mobile managers, and smart phones available from Palm, Inc. of Sunnyvale, Calif.; the pdQ smartphone, which is available from QUALCOMM Incorporated of San Diego, Calif.; and a variety of PDAs suitably equipped with attached wireless modems such as, for example, the Palm III and V connected organizers with Minstrel®. Other smart phones include those that support 3G technologies such as GMS UMTS/HSPDA and CDMA EV-DO. Other examples include wireless Palmtop modems and other wireless connectivity products available from Novatel Wireless Inc. of San Diego, Calif. Other examples include devices based on the Windows™ CE and Windows Mobile® operating system such as the various devices available from, for example, Compaq Computer of Houston, Tex., Hewlett Packard of Palo Alto, Calif., Casio Corporation of Tokyo, Japan; and various advanced data-enabled phones powered by the Symbian OS operating system available from Symbian Ltd. Of London, UK. Another illustrative platform is the Wireless Internet Device (“WID”), a type of device that includes the functionality of a phone as well as a PDA, WAP browser, and HTML browser. A family of products with WID capabilities is available from, for example Sony-Ericsson Mobile Communications, Inc. Any suitable wireless technology may be used, including, for example, GSM, CDMA, TDMA, GRPS, and UMTS. Examples of user input capabilities offered by these devices include keypad, keyboard, stylus, ink, handwriting recognition, voice recognition, and so forth. Personal electronic devices also include the many different types of tablet devices available from many different manufactures, including the iPad tablet available from Apple Computer Inc. of Cupertino, Calif., USA; and the Kindle wireless reading device available from Amazon.com Inc. of Seattle, Wash., USA.

Examples of personal electronic devices that have no or inadequate wireless communications capability include some personal digital assistants; some gaming devices; most audio and video players (including the popular iPod® mobile digital devices available from Apple Computer Corporation of Cupertino, Calif., USA, and the Zen MicroPhoto MP3 player available from Creative Labs Inc. of Milpitas, Calif., USA); most fobs; and USB Flash drives. Many of these devices have the ability to synchronize with or accept data from computers, and this capability may be used to furnish information to the personal electronic device that may later be communicated to the accessory and then in turn communicated in bar code form from the accessory to a bar code scanner. In the context of music downloads, for example, an audio player such as an iPod mobile digital device or a Zen MP3 player may receive a coupon for device accessories or other goods and services during the music download process, and that coupon may be presented while later shopping at a store by using the techniques described herein. Other personal electronic devices have numerous data transfer options. The Playstation® Portable device available from Sony Computer Entertainment America Inc. of Foster City, Calif., USA, for example, has Wi-Fi, USB, memory stick, and infrared I/O capabilities, any one of which may be used to receive a coupon. The Zune™ player available from Microsoft Corporation of Redmond, Wash. USA has Wi-Fi which may be used to receive a coupon.

Basic Technique for Communicating Bar Code Information with Light

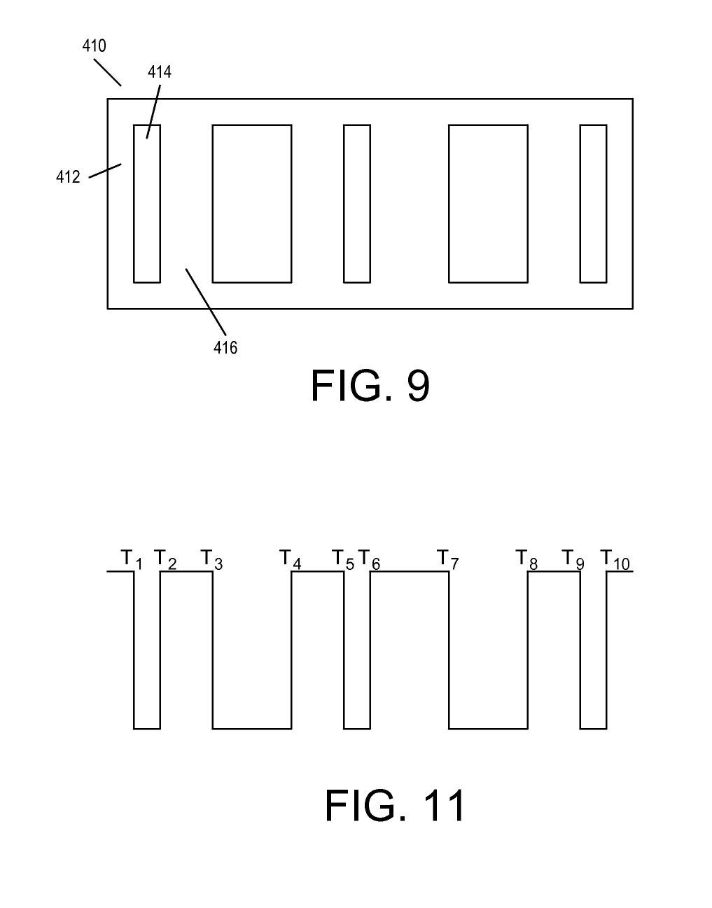

FIG. 9 shows a bar code 410 that utilizes a series of vertical lines, for example, bars 414, and spaces 416 to represent an identification code. Different combinations of the bars and spaces may be used to represent different characters.

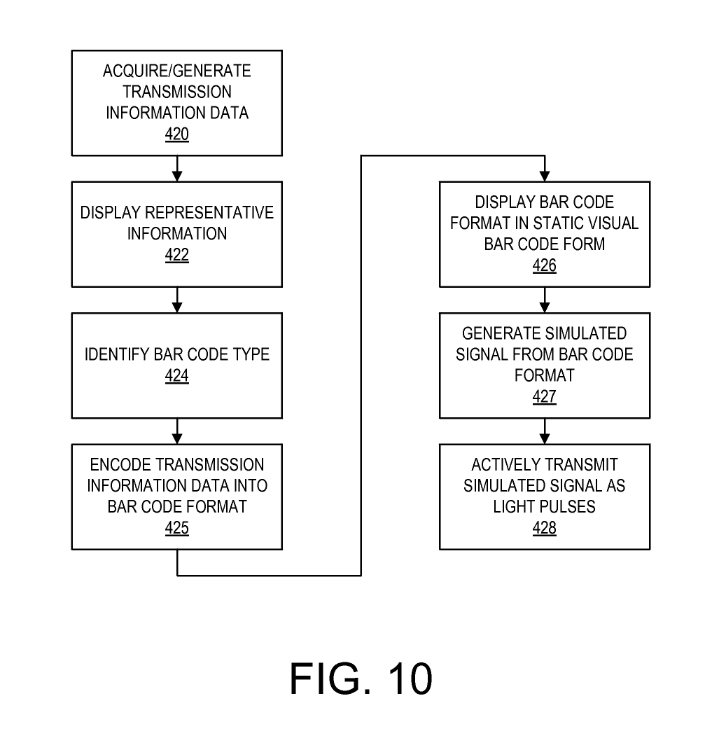

FIG. 10 shows a method of generating a signal for use with a sequential bar code scanner that simulates a bar code with light pulses. The method of FIG. 10 is particularly useful for sequential bar code scanners that use the reflection of a scanning beam being moved over a bar code. In block 420, transmission information data is acquired or generated. The transmission information data may be any type of data that one may wish to communicate while at a facility equipped with a bar code scanner, including information conventionally communicated using bar codes, as well as other types of information that are not conventionally communicated using bar codes because of, for example, physical limitations imposed by the bar code format. The transmission information data, for example, may include numeric, alphabetic, or alphanumeric data, an index, or other data values. The transmission information data may represent, for example, identification codes, boarding pass information, e-ticket information, ticket information, credit card information, debit card information, automated teller machine card information, identification information, account information, electronic payment information, wire transfer information, purchase information, security information, affinity information, and so forth.

The transmission information data may be stored locally on the personal electronic device, such as in random access memory (“RAM”) or read only memory (“ROM”), or acquired from a remote source. The personal electronic device may include, for example, static or dynamic RAM (“SRAM” or “DRAM,” respectively) memory, FLASH memory, other types of memory known in the art, or indeed any other type of memory. The transmission information data may be programmed into the device, entered into the device by the user, or received by the device from a remote source over any known communication technology such as wireless transmission, universal serial bus (“USB”) transmission, parallel transmission, and serial transmission. The remote source may be a personal computer, a wireless operator, a server networked to the wireless operator, a peer networked to the wireless operator, a wireless data port, and so forth.

In block 422, representative information for the transmission information data that will identify the transmission information data to a user of the personal electronic device is presented on an output facility of the device. The output facility may include, for example, a display such as an LCD screen of a PDA or wireless telephone, a speaker, or any other output device for communicating with a user. The representative information may include the transmission information data itself, or may be other information that the user will associate with the transmission information data. In order to identify the desired transmission information data item, the representative information that will identify that transmission information data item may be rendered, for example, in a textual, numerical, and/or graphical form and displayed on a screen of a suitably equipped personal electronic device, or an audio, video or multimedia message that is played by a suitably equipped personal electronic device. Boarding pass information may be displayed on a screen of a mobile phone, for example, identifying the airline, the flight and seat numbers, the date and departure time of the flight, and the gate number. In this manner, the user of the personal electronic device can identify the transmission information data that is to be presented, is being presented, or has been presented to the bar code scanner. If multiple transmission information data items are stored locally on the device and/or remotely retrieved, for example, the user can scan through them and select the appropriate transmission information data item to be presented to the bar code scanner.

If the personal electronic device lacks a screen or if the screen is too small, the representative information may be presented in other ways, such as by a spoken message or patterns of tones. Alternatively, the representative information need not be displayed.

In block 424, a bar code type is identified. The bar code type may be any type of barcode known in the art, such as, but not limited to, a UPC, EAN, Interleaved 2 of 5, Code 93, Code 128, and Code 39, or specially designed bar code types. Illustratively the bar code may be one dimensional or two dimensional.

In block 425, the transmission information data is encoded into a bar code format for the identified bar code type. The bar code format may be represented, for example, by a binary array. In a typical single-dimensional barcode, for example, the smallest width of a bar or space element of a bar code may be designated as a single element of an array. If the bar code has a width of 256 dots or pixels, and the smallest element of the bar code has a width of 4 dots or pixels, for example, a binary array having sixty four array elements (e.g., a1, a2, . . . , a64) may be used to represent the bar code format. Each array element is assigned a value depending on whether that portion of the bar code is part of a bar or a space. A bar, for example, may be designated as having a value equal to one (e.g., a1=1), and a space maybe designated as having a value equal to zero (e.g., a32=0). The array may also alternatively be a two-dimensional array, such as a bit map, that may be easily displayed on a screen. In yet another example, the transmission information data may be encoded into a digital series corresponding to a bar code representation of the bar code type selected in block 424. Alternatively, the transmission information data may be encoded into any number of other formats that may correspond to the selected bar code type identified in block 424. The bar code format may also be compressed or encrypted, such as when the bar code format is to be transmitted from a remote source to the personal electronic device.

Optionally, the transmission information data may be displayed in static visual bar code form as shown in block 426. In this manner, a personal electronic device can provide the transmission information date as a static visual bar code, which may be readable by CCD scanners and some types of sequential bar code scanners. Other visual information may be displayed as well, such as, for example, a visual image of a product corresponding to the transmission information.

In block 427, a signal to simulate the reflection of a scanning beam being moved across a visual image of the bar code format of block 425 is generated from the bar code format. The simulated signal may be generated corresponding to an approximated or measured scanning rate. If the simulated signal is to be generated for a scanner such as a laser scanner that utilizes a scanning rate in the range of about 30 to about 60 scans per second, the simulated signal may be generated using a scan rate within that range of scan rates (e.g., about 45 scans per second). Other types of scanners such as supermarket scanners are much faster, scanning at a rate of about 3000 to about 6000 scans per second. The simulation signal should be generated using a scan rate within that range. Alternatively, the simulated signal may be generated using a variable scan rate that is swept throughout a range of scan rates. Alternatively, the scan rate of the scanning beam may be measured where a receiver is available to detect the scanning beam. In this case, once the scanning rate or rates are determined, the signal is generated in block 427 corresponding to this scan rate or rates.

In block 428, the simulated signal is transmitted as light pulses. For purposes of the present description, the term “light” refers to visible light and infrared light spectra. The term “pulse” refers merely to a change in light level; the characteristics of the change, i.e. the specific waveform shape, are not critical. The light pulses may be generated in any visible or infrared wavelength desired by any light source known in the art, such as an LED, a laser, an infrared transmitter, a backlight of an LCD screen, or a light bulb.

The processing shown in FIG. 10 may be performed entirely in the personal electronic device. Alternatively, some or all of the processing shown in blocks 420, 422, 424, 425, and 427 may be performed upstream of the personal electronic device.

FIG. 11 shows an idealized representation of a signal that may be generated in block 427 of FIG. 10 for actual transmission as light pulses in block 428, by which is created light corresponding to the reflection of a scanning beam off bar code 410 (FIG. 9). The illustrative one-dimensional bar code 410 includes a quiet zone 412, bars 414, and spaces 416. While FIG. 9 shows a quiet zone 412 being lighter, the quiet zone may alternatively be darker if the scanner is adapted to recognize it. Correspondingly, the bars 414 and the spaces 416 may be inverted such that the bars 414 are lighter than the spaces 416. As a scanning beam scans across the quiet zone 412 and the spaces 416, the beam is reflected to the scanner. As the beam scans across the bars 414, however, the beam is absorbed (or at least the reflected beam has a lower amplitude than the beam reflected from the lighter quiet zone 412 and spaces 416). Thus, the amplitude of the beam received at the scanner decreases at times T1, T3, T5,T7 and T9, which correspond to the beam reaching a leading edge of a bar 414, and increases at time T2, T4, T6, T8 and T10, which correspond to the beam reaching the falling edge of a bar 414.

U.S. Pat. No. 6,685,093 issued Feb. 3, 2004 to Challa et al., U.S. Pat. No. 7,967,211 issued Jun. 28, 2011 to Challa et al., and U.S. Pat. No. 7,857,225 issued Dec. 28, 2010 to Challa et al., which hereby are incorporated herein in their entirety by reference thereto, describe techniques for effectively communicating information between a mobile communications device and a bar code reader, including the use of light-simulated bar codes.

The various embodiments of the invention described herein are illustrative of our invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention, as set forth in the following claims.

1. An apparatus for communicating information with a personal electronic device comprising:
a Near Field Communications (“NFC”) transceiver;
a light source;
a memory comprising:
a stored program component for encoding stored transmission information data from the memory into a bar code format;
a stored program component for generating a signal from the from the bar code format to simulate a reflection of a scanning beam being moved across a static visual image of the bar code format;
a stored program component for transmitting the signal as light pulses from the light source;
a stored program component for generating a first NFC protocol signal from transmission information data stored in the memory;
a stored program component for transmitting the first NFC protocol signal as an radio frequency signal from the NFC transceiver;
a stored program component for detecting a radio frequency signal received at the NFC transceiver and containing a second NFC protocol signal; and
a stored program component for generating and storing in the memory transmission information data from the second NFC protocol signal; and
a processor coupled to the NFC transceiver, the light source, and the memory for executing the program components stored in the memory.

2. The apparatus of claim 1 wherein the memory further comprises a stored program component for operating the NFC transceiver in one of a group of modes comprising NFC card emulation mode, NCF peer-to-peer mode, and NCF reader-writer mode.

3. The apparatus of claim 1 further comprising a fob housing, the NFC transceiver, the light source, the memory and the processor being components contained in the fob housing.

4. The apparatus of claim 1 further comprising a smartphone housing, the NFC transceiver, the light source, the memory and the processor being components contained in the smartphone housing.

5. The apparatus of claim 1 further comprising a tablet housing, the NFC transceiver, the light source, the memory and the processor being components contained in the tablet housing.

6. The apparatus of claim 1 further comprising Wi-Fi communications means and cellular communications means.

7. An apparatus for communicating information with a personal electronic device comprising:
a Near Field Communications (“NFC”) transceiver;
a light source;
a memory;
a processor coupled to the NFC transceiver, the light source, and the memory;
means for encoding stored transmission information data from the memory into a bar code format;
means for generating a signal from the from the bar code format to simulate a reflection of a scanning beam being moved across a static visual image of the bar code format;
means for transmitting the signal as light pulses from the light source;
means for generating a first NFC protocol signal from transmission information data stored in the memory;
means for transmitting the first NFC protocol signal as an radio frequency signal from the NFC transceiver;
means for detecting a radio frequency signal received at the NFC transceiver and containing a second NFC protocol signal; and
means for generating and storing in the memory transmission information data from the second NFC protocol signal.

8. A method for communicating information with a personal electronic device having a memory, a light source and a Near Field Communications (“NFC”) transceiver, comprising:
detecting a radio frequency signal received at the NFC transceiver and containing a NFC protocol signal;
generating and storing in the memory transmission information data from the NFC protocol signal;
encoding the transmission information data from the memory into a bar code format;
generating a signal from the from the bar code format to simulate a reflection of a scanning beam being moved across a static visual image of the bar code format; and
transmitting the signal as light pulses from the light source.

9. The method of claim 8 wherein the radio frequency signal detecting step and the transmission information data generating and storing step are performed in a NFC peer-to-peer mode.

10. The method of claim 8 wherein the radio frequency signal detecting step and the transmission information data generating and storing step are performed in a NFC reader-writer mode.
